(19) United States
(12) Patent Application Publication
(10) Pub. No.: US 2019/0188436 A1
(43) Pub. Date: Jun. 20, 2019

(54) GENERATING METHOD AND DECODING METHOD FOR A VERIFICATION CODE PRESENTED IN A FORM OF DYNAMIC RECOGNIZABLE TWO-DIMENSIONAL CODE

(71) Applicant: Kuei-Sheng TSOU, Hsinchu (TW)

(72) Inventor: Kuei-Sheng TSOU, Hsinchu (TW)

(21) Appl. No.: 16/281,914

(22) Filed: Feb. 21, 2019

Related U.S. Application Data
(63) Continuation-in-part of application No. 14/534,831, filed on Nov. 6, 2014, now abandoned.
Application No. 14/534,831 is a continuation-in-part of application No. 14/929,906, filed on Nov. 2, 2015, now abandoned.

(51) Int. Cl. G06K 7/14; G06F 3/14; G06F 3/0488

(52) U.S. Cl. CPC G06K 7/1417; G06F 3/0488; G06F 3/14

(57) ABSTRACT

A generating method and a decoding method for a verification code presented in a form of dynamic recognizable two-dimensional code are disclosed. The dynamic recognizable two-dimensional code is comprising at least a 2D code, at least a recognizable image, and at least a displaying pattern. The verification code is defined by the displaying pattern and used between two electronic devices for verification purposes, and the determination of the verification code may decide whether any subsequent operation is triggered depending on an application program. The verification code provides supreme reliability by displaying various types of the dynamic recognizable two-dimensional code to radically improve interaction security between electronic devices, and facilitate interaction convenience between user and the dynamic recognizable two-dimensional code, also the displaying electronic device, as a human-machine interface.

### CROSS-REFERENCE TO RELATED APPLICATION

This application is a continuation-in-part of U.S. patent application Ser. No. 14/534,831, filed on Nov. 6, 2014, and U.S. patent application Ser. No. 14/929,906 filed on Nov. 2, 2015, which are both incorporated herewith by reference.

### TECHNICAL FIELD

The technical field generally relates to a generating method and a decoding method for a verification code presented in a form of dynamic recognizable two-dimensional (2D) code; and in particular, relates to the generating and decoding to the verification code presented in a form of dynamic recognizable two-dimensional code that is used for interaction between electronic devices, and also directly used for interaction between the displayed dynamic recognizable two-dimensional code and humans.

### BACKGROUND

Two-dimensional (2D) codes are widely used in the current market. Some of the common 2D-code includes Code 49, Code 16K, PDF417, SuperCode, Dot Code A, USS Code One, MaxiCode, Data Matrix, Aztec Code, QR Code and the like.

The Quick Response Code (QR-code) is one of matrix barcodes which was originally designed for industrial applications, but has gained popularity in consumer market.

With the advancement of technology and application, additional features are continuously added to the QR-code; one of the common added features is the recognizability to human eyes, which also leads to the creation of customized style. For example, when selecting a QR-code for the user, a recognizable QR-code is developed to include a static image that is recognizable to human eye, to enhance convenience to users. However, the basic function of the QR-code in commercial and advertising application remains the same. That is, a capturing device captures a QR-code; and after decoding the captured QR-code, the capturing device displays the data represented by the QR-code, transmits and receives data, or links to a specific website.

Recently, there are some applications that have been using stacked QR-codes to carry more data, improve marketing attractiveness or trading security in the booming E-commerce era.

### SUMMARY

In view of the drawbacks of the prior art, the objective of the present invention is to provide a generating method and a decoding method for a verification code presented in a form of dynamic recognizable two-dimensional code.

An exemplary embodiment describes a generating method for a verification code presented in a form of dynamic recognizable two-dimensional code of the present invention, applicable to a displaying electronic device with a display unit, includes the following steps of: providing at least a two-dimensional code, wherein the two-dimensional code is an image formed by encoding a plurality of data according to a two-dimensional code format; providing at least a recognizable image, wherein the recognizable image is recognizable by human eyes, but not recognizable by a two-dimensional code decoder in compliance with its own two-dimensional code formats; providing at least a displaying pattern, wherein the displaying pattern defines a number of frames of displayed images, a displaying sequence of each of the displayed images, a displaying duration of each of the displayed images, and a time lapse to a displayed image next in the sequence, defined as the time lapse between a displayed image ending and a next displayed image appearing, and wherein each of the displayed images being one of the at least a two-dimensional code or the at least a recognizable image; defining the two-dimensional code and the recognizable image respectively represent two different states, expressed by a binary number 1 and 0 respectively, the state 1 and the state 0 are opposite; displaying the at least a two-dimensional code and the at least a recognizable image in accordance with the at least a displaying pattern sequentially stacked onto the display unit of the displaying electronic device to obtain a verification code presented in a form of dynamic two-dimensional code.

According to a preferred embodiment, the recognizable image is an image that is recognizable by human eyes, and the recognizable image also includes a non-recognizable two-dimensional code that is a two-dimensional code but cannot be recognized by the two-dimensional code decoder in compliance with its own two-dimensional code formats, a blank image, a transparent page, or any combination of the above.

According to a preferred embodiment, the displaying duration of each of the displayed images is not all the same, and the time lapse to a displayed image next in the sequence is not all zero.

According to a preferred embodiment, the displaying duration of each of the displayed images is the same, and the time lapse to a displayed image next in the sequence is zero.

According to a preferred embodiment, the display unit is a touch screen, when a user directly touching the recognizable image of the dynamic recognizable two-dimensional code displayed on the display unit, the touching can be interpreted as a data input, an instruction, a response or a confirmation to the dynamic recognizable 2D code, an application program stored in a storage unit of the displaying electronic device detects the touching and triggers the subsequent operation defined in the application program.

Another exemplary embodiment describes a decoding method for a verification code presented in a form of dynamic recognizable two-dimensional code of the present invention, applicable to a capturing electronic device having a camera unit, comprising the following steps: capturing the dynamic recognizable two-dimensional code displayed on the display unit of the displaying electronic device; in the captured dynamic recognizable two-dimensional code, using a two-dimensional code decoder to decode all of the included displayed images and determine if the displayed image is the two-dimensional code or the recognizable image, and the displaying pattern in compliance with its own two-dimensional code formats; defining the displayed image determined to be a two-dimensional code as a first state, defining the displayed image determined to be a recognizable image as a second state, wherein the first state and the second state are opposite states, and expressed by a binary number 1 and 0 respectively; computing to obtain a verification code according to the number of frames of displayed images, the displaying sequence of each of the displayed images, the displaying duration of each of the displayed images, the time lapse to a displayed image next in the sequence, and the states represented by the two-dimensional codes and the recognizable images; determining whether to proceed with subsequent operation according to the verification code.

According to a preferred embodiment, the subsequent operation includes interaction between the displaying electronic device and the capturing electronic device.

According to a preferred embodiment, the subsequent operation includes decoding and using the data encoded in the two-dimensional codes of the dynamic recognizable two-dimensional code.

The generating method and the decoding method for a verification code presented in a form of dynamic recognizable two-dimensional code of the present invention can display various types of the dynamic recognizable two-dimensional code by setting a displaying pattern. Together with decoding of the verification code presented in a form of dynamic recognizable two-dimensional code, the present invention improves users' convenience and facilitates various interactions and improved security of interaction between electronic devices.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1A and FIG. 1B are flow charts respectively showing the generating method and decoding method of a verification code presented in a form of dynamic recognizable two-dimensional (2D) code in accordance with a preferred embodiment of the present invention.

FIG. 2 is a schematic view consistent with the preferred embodiment of FIG. 1, and shows a plurality of valid 2D codes and recognizable images of the present invention.

FIG. 3 is a schematic view consistent with the preferred embodiment of FIG. 1, and shows displaying pattern, a plurality of displayed images and verification code according to the present invention.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

It should be noted that the structures, proportions, sizes and the like of the drawings of the current specification are only for depicting the disclosures of the present invention, to enable easy reading and understanding by persons skilled in the art, and these are not meant to be conditions that limit the present invention. As such, the drawings are not technologically meaningful. Any modifications of the structure, proportion relationships or any adjustments of the sizes should fall within the scope that is covered by the technical content of the present invention, without affecting the effects produced by the present invention and without affecting the goals of the present invention.

In the following preferred embodiments, the QR code is used as an example of the two-dimensional (2D) code, in order to describe the structure and use of the present invention. However, it should be noted that, the technical features of the present invention is also suitable for other types of 2D code formats.

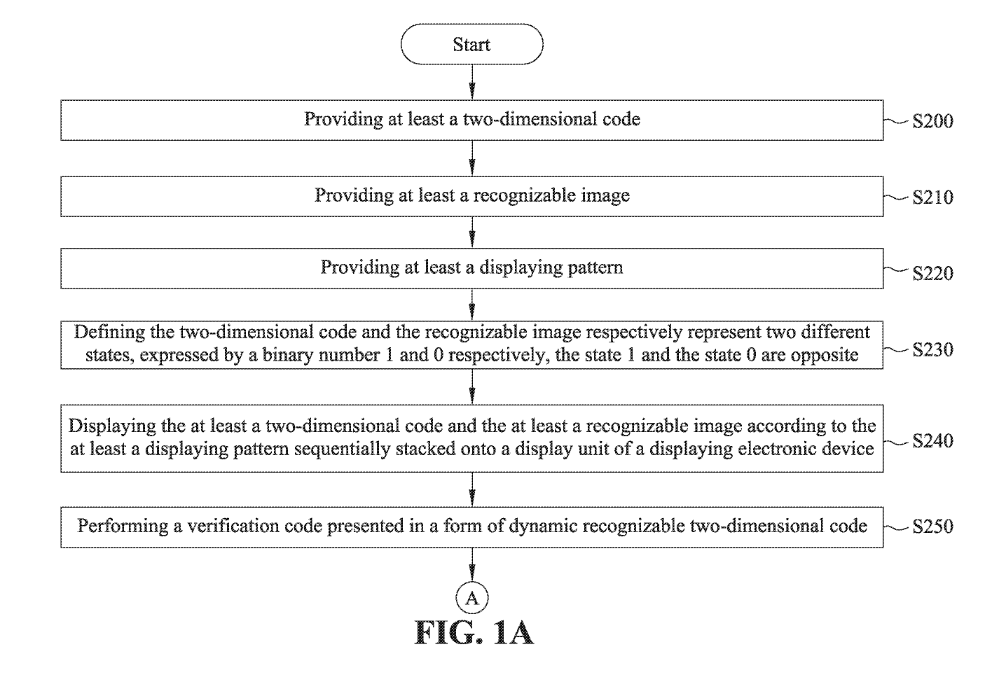

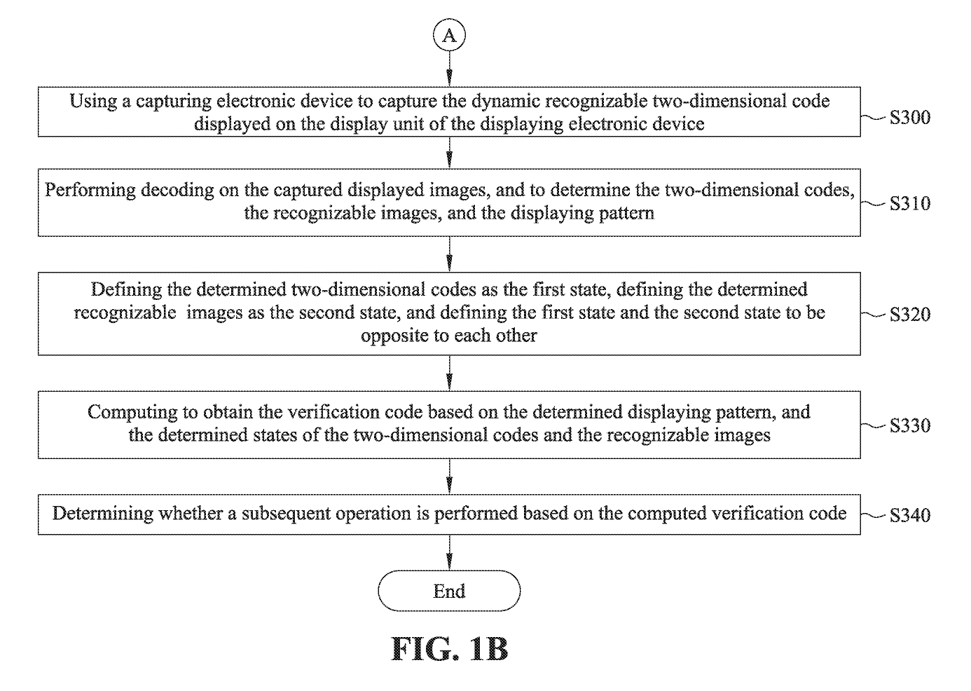

FIG. 1A and FIG. 1B are flow charts respectively showing the generating method and decoding method of a verification code presented in a form of dynamic recognizable two-dimensional (2D) code in accordance with a preferred embodiment of the present invention. As shown in FIG. 1A, the generating method for the verification code presented in a form of dynamic recognizable 2D code of the present invention includes the following steps:

Step S200: providing at least a two-dimensional code; at least a 2D code is provided, wherein the 2D code is an image representing a plurality of data and encoded in compliance with a 2D code format.

Step S210: providing at least a recognizable image; at least a recognizable image is provided, wherein the recognizable image is an image that is recognizable by human eyes, but cannot be recognized by a two-dimensional code decoder in compliance with its own two-dimensional code formats.

Step 220: providing at least a displaying pattern; at least a displaying pattern is provided, wherein the displaying pattern defines a number of frames of displayed images, a displaying sequence of each of the displayed images, a displaying duration of each of the displayed images, and a time lapse to a displayed image next in the sequence, defined as the time lapse between a displayed image ending and a next displayed image appearing, and wherein each of the displayed images being one of the at least a two-dimensional code or the at least a recognizable image.

Step 230: defining the two-dimensional code and the recognizable image respectively represent two different states, expressed by a binary number 1 and 0 respectively, the state 1 and the state 0 are opposite.

Step 240: displaying the at least a two-dimensional code and the at least a recognizable image according to the at least a displaying pattern sequentially stacked onto a display unit of a displaying electronic device.

Step 250: performing a verification code presented in a form of dynamic recognizable two-dimensional code.

It should be noted that the displaying pattern may be changed to meet requirements of different applications. The display unit of the electronic device may display the various dynamic recognizable 2D codes.

Based on the aforementioned generating method, as shown in FIG. 1B, a corresponding decoding method for the verification code presented in a form of dynamic recognizable 2D code of the present invention comprises the following steps:

Step 300: using a capturing electronic device to capture the dynamic recognizable two-dimensional code displayed on the display unit of the displaying electronic device. For example, a camera unit of a capturing electronic device is used to capture the dynamic recognizable two-dimensional code displayed on the display unit of the displaying electronic device. However, the exemplar is only illustrative, instead of restrictive.

Step S310: performing decoding on the captured displayed images, and to determine the two-dimensional codes, the recognizable images and the displaying pattern; wherein using a two-dimensional code decoder to decode all of the captured displayed images of the dynamic recognizable two-dimensional code and determine if the each of captured displayed images is the two-dimensional code or recognizable image according to that the two-dimensional code formats the two-dimensional code decoder complies with.

Step S320: defining the determined two-dimensional codes as the first state, defining the determined recognizable images as the second state, and defining the first state and the second state to be opposite to each other; in other words, defining the displayed image determined to be a two-dimensional code as a first state, defining the displayed image determined to be a recognizable image as a second state, wherein the first state and the second state are opposite states, and expressed by a binary number 1 and 0 respectively.

Step 330: computing to obtain the verification code based on the determined displaying pattern, and the determined states of the two-dimensional codes and the recognizable images; in other words, computing to obtain a verification code according to the number of frames of displayed images, the displaying sequence of each of the displayed images, the displaying duration of each of the displayed images, the time lapse to a displayed image next in the sequence, and the states represented by the two-dimensional codes and the recognizable images.

Step S340: determining whether a subsequent operation is performed based on the computed verification code.

It should be noted that the number of the displayed images, the displaying sequence of each of the displayed images, the displaying duration of each of the displayed images, and the time lapse between the displayed images may be changed to meet requirements of different applications. The display unit of the displaying electronic device may display the various dynamic recognizable 2D codes, and all of the dynamic recognizable 2D codes respectively represent own verification code.

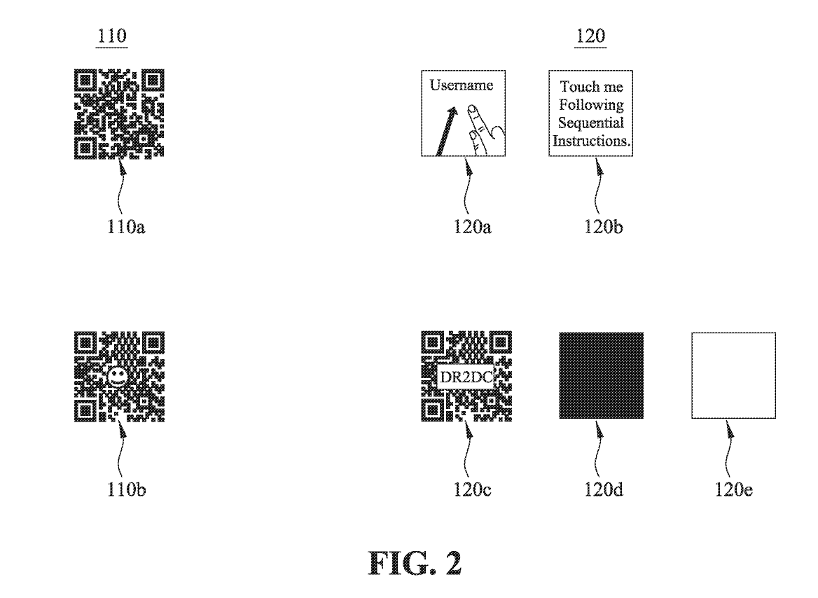

FIG. 2 is a schematic view consistent with the preferred embodiment of FIG. 1, and shows a plurality of valid 2D codes 110 and recognizable images 120 of the present invention. As shown in FIG. 2, the 2D codes 110a and 110b are both valid exemplary embodiments of the 2D code 110; and the recognizable images 120a, 120b, 120c, 120d and 120e are all valid exemplary embodiments of the recognizable images 120.

It should be noted that the 2D code 110a is a conventional QR code while the QR code 110b is a valid QR code partially overlapped by an image recognizable to the human eyes. It should also be noted that the difference between the QR code embodiment 110b and recognizable image embodiment 120c is the area ratio occupied by the image overlapping the data area of a QR code. The QR code format defines several error correction levels which may render a damaged QR code still decodable; in other words, the QR code 110b is a damaged QR code partially overlapped by an image and it can be decoded by a 2D code decoder in compliance with the QR code format, but the damaged QR code 120c cannot be decoded by a 2D code decoder in compliance with the QR code format.

Moreover, the recognizable image is defined as an image that is recognizable by human eyes, but cannot be recognized by a 2D code decoder in compliance with its own two-dimensional code formats; therefore, pictures, drawings, dolls, trees, flowers, grasses, numerical signs, company trademarks, photos, undecodable 2D codes, blank pages, transparent pages or any combination of the above are all defined as recognizable image.

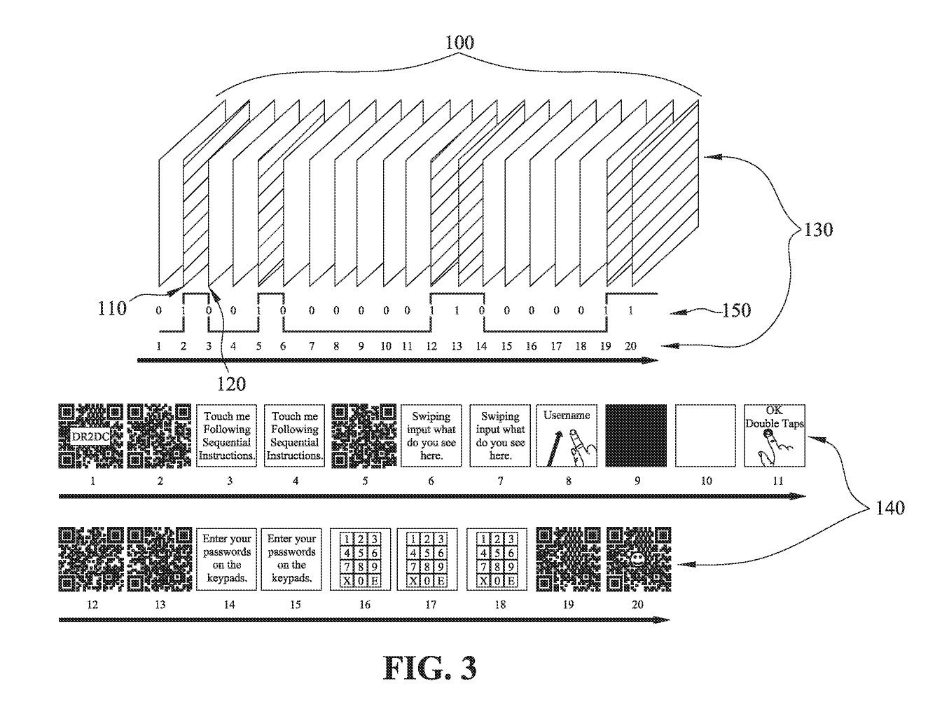

FIG. 3 is a schematic view consistent with the preferred embodiment of FIG. 1, and shows a displaying pattern 130, a plurality of displayed images 140, and a verification code 150 according to the present invention. As shown in FIG. 3, a dynamic recognizable 2D code 100 is displayed according to a displaying pattern, wherein the displaying pattern defines a number of frames of displayed images, a displaying sequence of each of the displayed images, a displaying duration of each of the displayed images, and a time lapse to a displayed image next in the sequence, defined as the time lapse between a displayed image ending and a next displayed image appearing, and wherein each of the displayed images being one of the at least a two-dimensional code or the at least a recognizable image; the two-dimensional code and the recognizable image respectively represent two different states, expressed by a binary number 1 and 0 respectively, the state 1 and the state 0 are opposite; and a performed verification code is obtained when the dynamic recognizable 2D code is displayed by a displaying unit of a displaying electronic device according to the displaying pattern, or the dynamic recognizable 2D code is displayed by a displaying unit of a displaying electronic device and captured by a camera module of a capturing electronic device and decoded by a 2D code decoder according to the displaying pattern. In the exemplar, the displaying pattern comprises 20 displayed images, and some of the displayed images are identical, that is, the same 2D code or the same recognizable image are used at different positions in the displaying sequence of the displaying pattern.

Refer to FIG. 2 and FIG. 3, the verification code 150 presented in a form of dynamic recognizable 2D code 100 are applicable to a displaying electronic device able to display with a display unit the dynamic recognizable 2D code 100, and a capturing electronic device able to capture with a camera unit the dynamic recognizable 2D code 100 displayed on the display unit of the displaying electronic device, and a 2D code decoder able to decode the captured dynamic recognizable 2D code 100. The displaying pattern 130 has a display period T. The at least a 2D code 110 is formed by converting a plurality of data into an image encoded in compliance with a 2D code format. The at least a recognizable image 120 is an image that is recognizable by human eyes, and is an image that cannot be recognized by a 2D code decoder in compliance with its own 2D code formats. As aforementioned, the 2D code 110 and the recognizable image 120 represented two opposite states. For example, the two opposite states are “1” and “0”, or “high” and “low”, respectively.

The displaying pattern defines the number of frames of displayed images, the displaying sequence of each of the displayed images, the displaying duration (the length of the displaying of the displayed image) of each of the displayed images, and a time lapse to a displayed image next in the sequence, defined as the time lapse between a displayed image ending and a next displayed image appearing, and wherein each of the displayed images being one of the at least a two-dimensional code or the at least a recognizable image. Also, the dynamic recognizable 2D code may be displayed cyclically.

Moreover, it should be noted that the displaying duration of each of the displayed images may or may not be the same, and the time lapse to a displayed image next in the sequence may or may not be zero. A zero time lapse to a displayed image next in the sequence means that the next displayed image appears immediately after the previous displayed image ends.

In the embodiment shown in FIG. 3, the displaying pattern 130 has a display period T and comprises twenty displayed images 140 (six 2D codes 110 and fourteen recognizable images 120) with each being set with a one-twentieth of the display period T for displaying duration, and time lapse being set as zero (i.e., the next displayed image is displayed immediately following the previous displayed image).

The verification code 150 is a sequence of 20 bits of 1s and 0s. It should be noted that the displaying duration and the time lapse associated with each displayed image are not shown in FIG. 3.

However, it should be noted that the exemplary embodiment is only illustrative, instead of restrictive. A different displaying pattern can be defined based on application requirements. That is, the number of displayed images, the displaying sequence, the displaying duration and the time lapse of each of the displayed images in the displaying pattern may all be changed to meet requirements of different applications. Moreover, the display unit of an electronic device may display the various dynamic recognizable 2D codes, and all of the various dynamic recognizable 2D codes respectively represent own verification code.

A verification code presented in a form of dynamic recognizable 2D code can be used between two electronic devices for verification purpose. For example, when a dynamic recognizable 2D code is displayed by a display unit of a displaying electronic device and captured by a camera unit of a capturing electronic device according to a displaying pattern, and a verification code formed by a sequence of “1” and “0” is obtained; the determination of the verification code may decide whether any subsequent operation is triggered depending on an application program. The subsequent operation may further include performing interactive operations between the two electronic devices, or may further include deciding whether or not to perform the decoding (of) and using the data encoded in the 2D codes of the dynamic recognizable 2D code captured by the capturing electronic device.

Moreover, when a user directly touches the recognizable images of the dynamic recognizable 2D code displayed on a touch screen of an electronic device, the user's touch is detected by an application program stored in a storage unit of the electronic device, and the touch can be interpreted as a data input, an instruction, a response or a confirmation to the dynamic recognizable 2D code. Therefore, a user's touching to the dynamic recognizable 2D code detected by the application program can trigger one or more subsequent operations defined by the application program. The subsequent operation may, but not limited to, change the data of the 2D codes or displayed images of the dynamic recognizable 2D code, or change the dynamic recognizable 2D code and the verification code by changing the displaying pattern, and so on. Therefore, the dynamic recognizable 2D code can be used directly as a human-machine interface between human and machine.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A generating and decoding method for a verification code presented in a form of dynamic recognizable two-dimensional code, comprising the following steps of:
providing at least a two-dimensional code, wherein the two-dimensional code is an image formed by encoding a plurality of data according to a two-dimensional code format;
providing at least a recognizable image, wherein the recognizable image is recognizable by human eyes, but not recognizable by a two-dimensional code decoder in compliance with its own two-dimensional code formats;
providing at least a displaying pattern, wherein the displaying pattern defines a number of frames of displayed images, a displaying sequence of each of the displayed images, a displaying duration of each of the displayed images, and a time lapse to a displayed image next in the sequence, defined as the time lapse between a displayed image ending and a next displayed image appearing, and wherein each of the displayed images being one of the at least a two-dimensional code or the at least a recognizable image;
defining the two-dimensional code and the recognizable image respectively represent two different states, expressed by a binary number 1 and 0 respectively, the state 1 and the state 0 are opposite;
displaying the at least a two-dimensional code and the at least a recognizable image in accordance with the at least a displaying pattern sequentially stacked onto a display unit of a displaying electronic device to obtain a verification code presented in a form of dynamic recognizable two-dimensional code;
using a capturing electronic device to capture the dynamic recognizable two-dimensional code displayed on the display unit of the displaying electronic device;
using a two-dimensional code decoder to decode the captured displayed images, and to determine if the each of captured displayed images is the two-dimensional code or the recognizable image and the displaying pattern according to the two-dimensional code decoder's own two-dimensional code formats;
defining the displayed image determined to be a two-dimensional code as a first state, defining the displayed image determined to be a recognizable image as a second state, wherein the first state and the second state are opposite states, and expressed by a binary number 1 and 0 respectively;
computing to obtain a verification code according to the determined displaying pattern, including the number of frames of displayed images, the displaying sequence of each of the displayed images, the displaying duration of each of the displayed images, the time lapse to a displayed image next in the sequence, and the determined states represented by the two-dimensional codes and the recognizable images; and
determining whether a subsequent operation is performed based on the computed verification code.

2. The generating and decoding method for a verification code presented in a form of dynamic recognizable two-dimensional code as claimed in claim 1, wherein the recognizable image also includes a blank page or a transparent page.

3. The generating and decoding method for a verification code presented in a form of dynamic recognizable two-dimensional code as claimed in claim 1, wherein the displaying duration of each of the displayed images is not all the same, and the time lapse to a displayed image next in the sequence is not all zero.

4. The generating and decoding method for a verification code presented in a form of dynamic recognizable two-dimensional code as claimed in claim 3, wherein the displaying duration of each of the displayed images is the same, and the time lapse to a displayed image next in the sequence is zero.

5. The generating and decoding method for a verification code presented in a form of dynamic recognizable two-dimensional code as claimed in claim 1, wherein the display unit is a touch screen; when a user directly touching the recognizable image of the dynamic recognizable two-dimensional code displayed on the display unit, the touching is detected by an application program stored in a storage unit of the electronic device, and triggers a subsequent operation defined by the application program.

6. The generating and decoding method for a verification code presented in a form of dynamic recognizable two-dimensional code as claimed in claim 1, wherein the subsequent operation includes interaction between the displaying electronic device and the capturing electronic device.

7. The generating and decoding method for a verification code presented in a form of dynamic recognizable two-dimensional code as claimed in claim 1, wherein the subsequent operation includes decoding and using the data encoded in the two-dimensional codes of the dynamic recognizable two-dimensional code.
